(19) United States
(12) Patent Application Publication
(10) Pub. No.: US 2015/0081694 A1
(43) Pub. Date: Mar. 19, 2015

(54) MULTI-TEMPORAL WIDELY DISTRIBUTED HARDWARE AND SOFTWARE TRANSACTION STATE AND DATA STATE MEMORY SYSTEM

(71) Applicant: International Business Machines Corporation, Armonk, NY (US)

(72) Inventors: Robert R. Friedlander, Southbury, CT (US); James R. Kraemer, Santa Fe, NM (US); Jeb Linton, Manassas, VA (US)

(73) Assignee: International Business Machines Corporation, Armonk, NY (US)

(21) Appl. No.: 14/030,544

(22) Filed: Sep. 18, 2013

(51) Int. Cl. G06F 17/30

(52) U.S. Cl. CPC G06F 17/30312; G06F 17/30424; G06F 17/30958
USPC 707/736

(57) ABSTRACT

A method, in a multi-temporal widely distributed hardware and software transaction state and data state memory system, the steps comprising: creating an entry within the metadata layer for a first access to a data item within the data structure at a time-equals-zero state to create a time-equals-zero version branch of the data item in a graph structure of the data structure at a time-equals-zero time; updating the graph structure within the metadata layer when a copy-on-write overlay is generated by creating an additional branch connected to a same node as the time-equals-zero branch, storing a set of characteristics regarding the copy-on-write overlay within the metadata layer; updating the graph structure to reflect a status of propagated changes from the copy-on-write overlay to the plurality of computers; and storing a set of characteristics regarding the propagated changes to the plurality of computers.

### BACKGROUND

The present invention relates to a hardware and software transaction state and data state memory system, and more specifically to a multi-temporal widely distributed hardware and software transaction state and data state memory system.

Very large scale systems across multiple hardware and software systems has data in large-scale data stores and is distributed over hundreds or thousands of servers and can be updated by hundreds of clients. Conventionally, snapshot isolation is used to update data within the system. Snapshot isolation is technique in which all reads made in a transaction will see a consistent snapshot of the database. In other words, the system reads the last committed values that existed within the database that existed at the time the transaction was started. The transaction only successfully commits the update if no updates within the transaction have a conflict with any concurrent updates made since the snapshot.

### SUMMARY

According to one embodiment of the present invention, a method, in multi-temporal widely distributed hardware and software transaction state and data state memory system comprising a plurality of computers, of initiating a change to a data structure comprising a plurality of databases and a metadata layer linking the plurality of databases and the plurality of computers. The method comprising the steps of: a computer creating an entry within the metadata layer for a first access to a data item within the data structure at a time-equals-zero state to create a time-equals-zero version branch of the data item in a graph structure of the data structure at a time-equals-zero time; the computer updating the graph structure within the metadata layer when a copy-on-write overlay is generated by creating an additional branch connected to a same node as the time-equals-zero branch, to represent a change to a state of the of the data item and maintaining a co-existing alternate version of the data item, separate from the time-equals-zero version; the computer storing a set of characteristics regarding the copy-on-write overlay within the metadata layer; the computer updating the graph structure to reflect a status of propagated changes from the copy-on-write overlay to the plurality of computers; and the computer storing a set of characteristics regarding the propagated changes to the plurality of computers.

### BRIEF DESCRIPTION OF THE SEVERAL VIEWS OF THE DRAWINGS

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a schematic of an overview of a data structure of a multi-temporal widely distributed hardware and software transaction state and data state memory system of an embodiment of the present invention.

FIG. 5 shows an example of a first state of a portion of the data structure at a first timestamp within the metadata layer.

FIG. 6 shows an example of a second state of a portion of the data structure at a second timestamp within the metadata layer.

FIG. 7 shows an example of a third state of a portion of the data structure at a third timestamp within the metadata layer.

FIG. 8 shows a flow diagram of a method of creating and updating data regarding characteristics of a data item of a data structure within a metadata layer of a multi-temporal widely distributed hardware and software transaction state and data state memory system.

FIG. 9 shows a flow diagram of a method of searching for information regarding updates made to the data structure of a multi-temporal widely distributed hardware and software transaction state and data state memory system.

### DETAILED DESCRIPTION

In an illustrative embodiment of the present invention, the use of multiple levels of transaction branching across machines and software systems is controlled through multiple atomicity elements, which are flexible and have temporality and unit constancy. This alleviates limitations of size and scope of very large scale, transactional level, consistent active memory systems, and may enable truly massive systems to be configured as stand-alone machines linked to a cloud infrastructure, mobile processors or hybrids thereof.

In an illustrative embodiment of the present invention, a data item is an atomic state of a particular object concerning a specific property at a certain time point. A data item may be a software program or interact with a software program. A collection of data items for the same object at the same time forms an object instance. Any type of complex information can be broken down to elementary data items (atomic state) with the data items being identified by at least object, property and time.

In an illustrative embodiment of the present invention, temporality refers to a state of a data item existing within or having some relationship with time, for example a time maintained within the system through a timestamp system.

In an illustrative embodiment of the present invention, the system of the present invention has a guarantee of atomicity, which prevents updates to data items within a data structure from occurring only partially, which can cause greater problems than rejecting the whole series outright.

In an illustrative embodiment of the present invention, transactions of a system may be entered into active memory across the system, into various active memory units on various hardware, managed under various software with defined levels of granularity and temporal states.

In an illustrative embodiment of the present invention, the system of the present invention enables fast instantiation of the virtual machines or processes per branch.

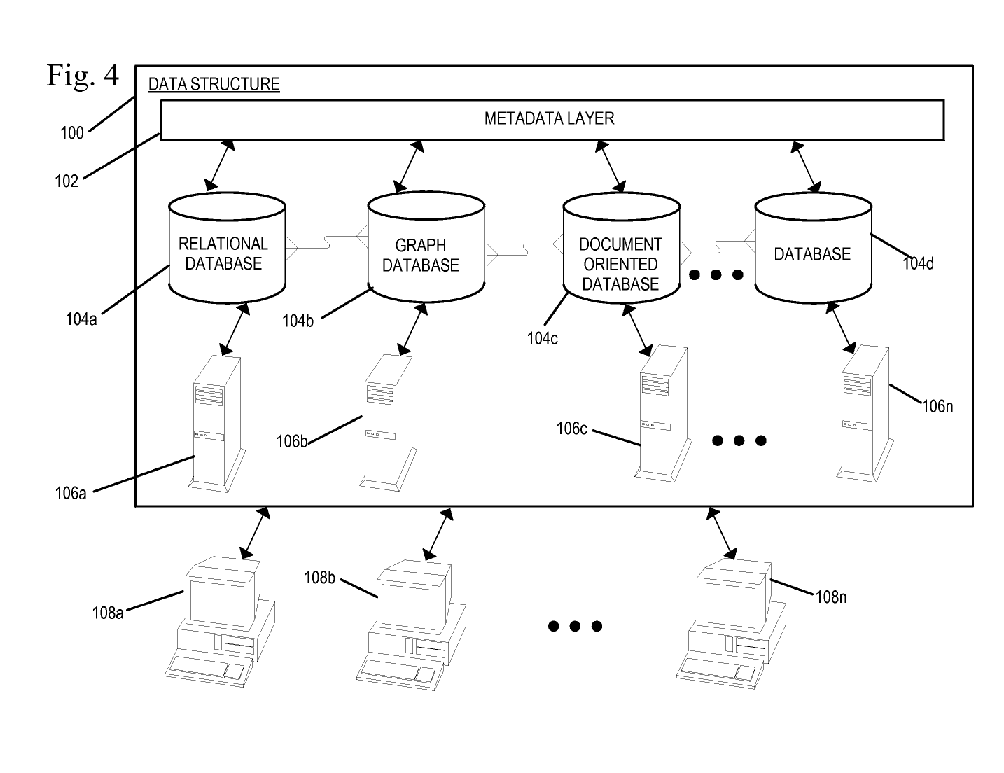

FIG. 4 shows a schematic of an overview of a data structure of a multi-temporal distributed hardware and software transactional and longitudinal memory system of an embodiment of the present invention.

The data structure 100 is preferably of a very large scale, extending across multiple hardware and software systems and has data items in large-scale data stores, for example relational databases 104a, graph databases 104b, document oriented databases 104c, and other types of databases 104n. The data stores 104a-104n are distributed over hundreds or thousands of servers 106a-106n each with active memory units managed by software with defined levels of granularity and temporal states. The data items within the data stores 104a-104n can be updated by hundreds of clients 108a-108n. The clients 108a-108n may be local computing devices used by cloud consumers, virtual machines, or other devices.

Within the data structure 100 is a metadata layer 102 that maintains and tracks all temporality states of a data item, including, but not limited to timestamps of when the data item was updated across specified machines, which user created the updated data item, success of the update, anomalous behavior, failure states, security levels, and other characteristics. The characteristics listed are examples of what may be tracked, any characteristic of regarding the data items within the system may be also be stored on the metadata layer 102.

The metadata layer 102 contains all states of all versions of data items organized into a graph structure with nodes, branches and sub-branches exemplifying relationships between the versions of the data items and between other components of the system. Data regarding data items within the data structure 100 are present longitudinally across the components of the system, for example multiple databases 104a-104n, servers 106a-106n and/or clients 108a-108n. The metadata layer may also be present within the cloud computing environment 50.

Even if data items of data structure are updated or replaced during a lifetime of the system, all previous versions from a time-equals-zero state version are present through the current version. A state of a data item is never removed from the metadata layer 102. A computer within the data structure 100 can query and manage the metadata layer 102 and commitment of changes to data items within the data structure 100 that take place through time.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

It will be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

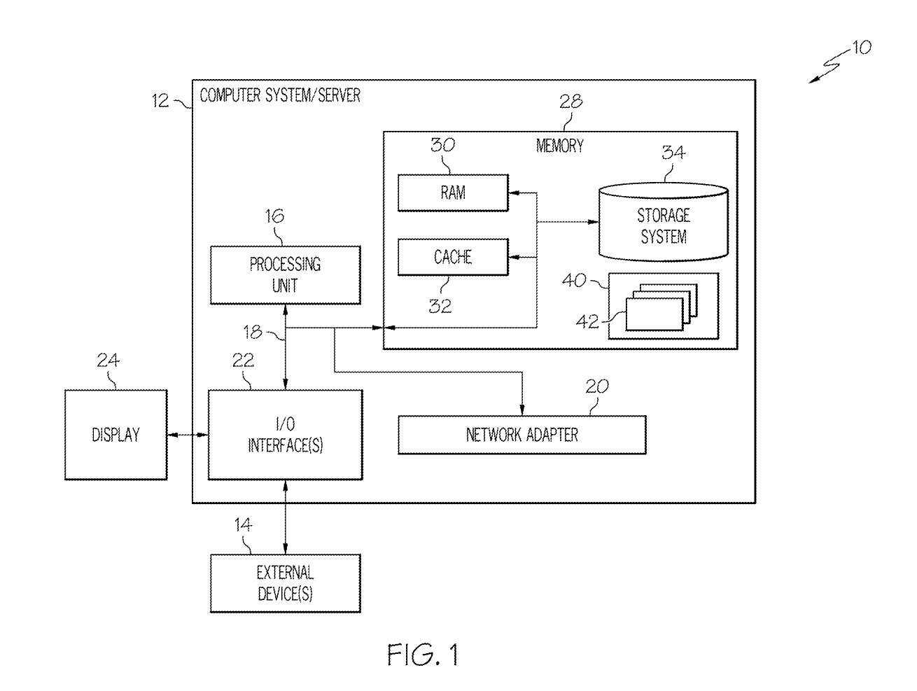

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. The computer system/server 12 also includes servers 106a-106n, and clients 108a-108n of FIG. 4.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

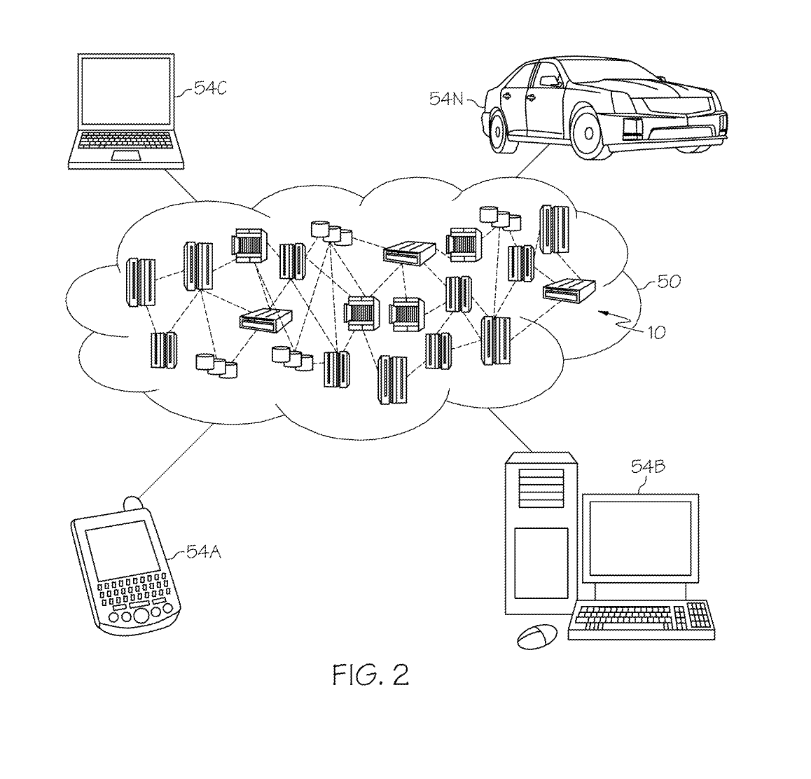

Referring now to FIG. 2, an illustrative cloud computing environment 50 is depicted. As shown, cloud computing environment 50 comprises one or more cloud computing nodes 10 with which local computing devices used by cloud consumers, or clients, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 or clients 108a-108n (FIG. 4) are intended to be illustrative only and that computing nodes 10 and cloud computing environment 50 can communicate with any type of computerized device over any type of network and/or network addressable connection (e.g., using a web browser).

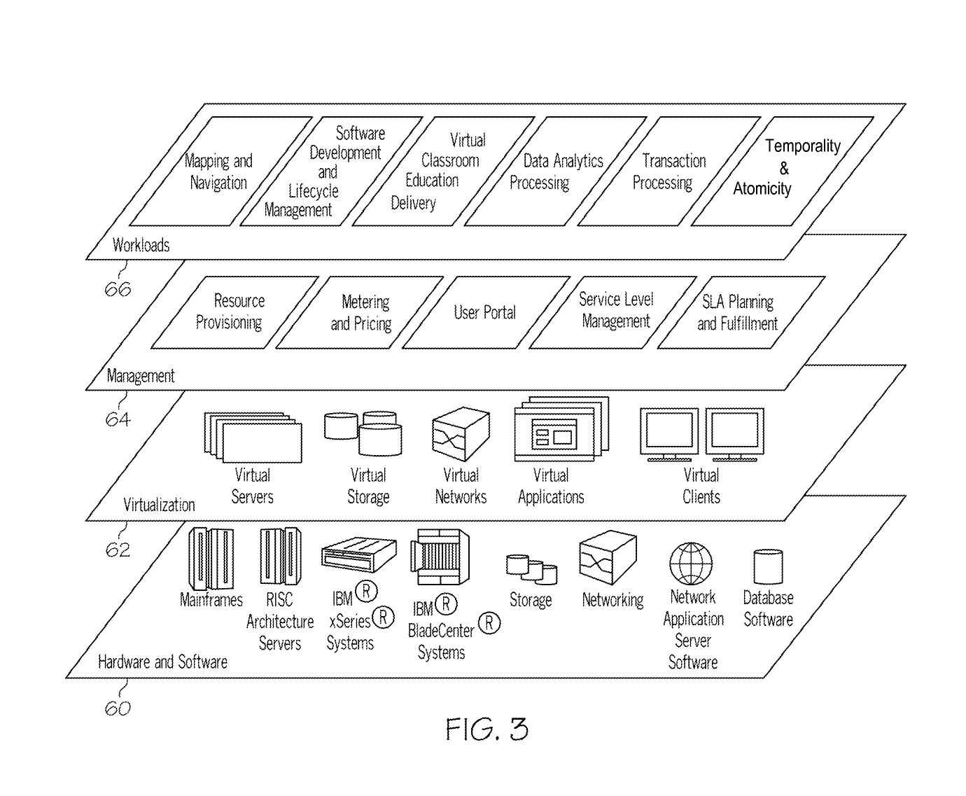

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and temporality and atomicity.

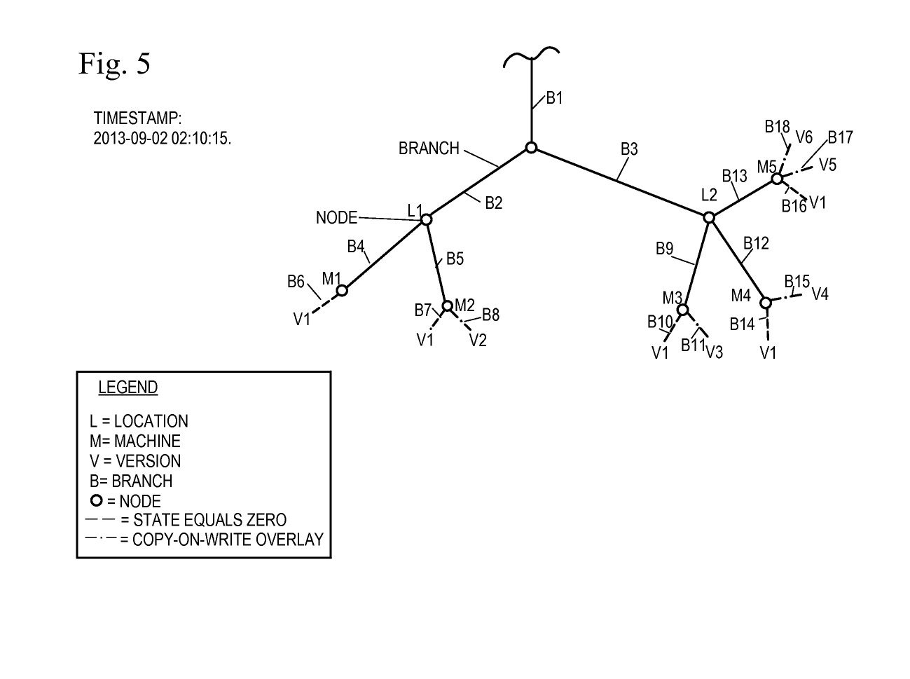

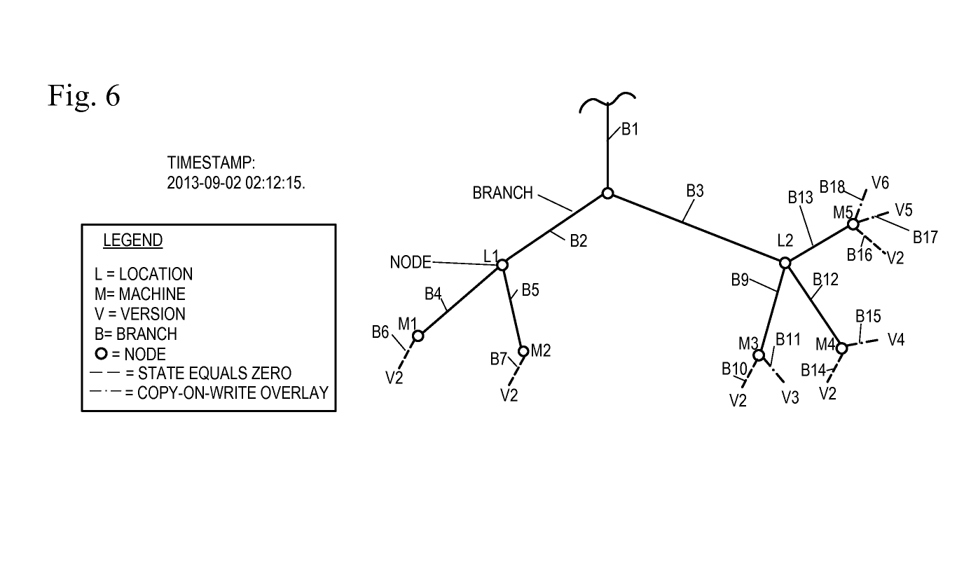

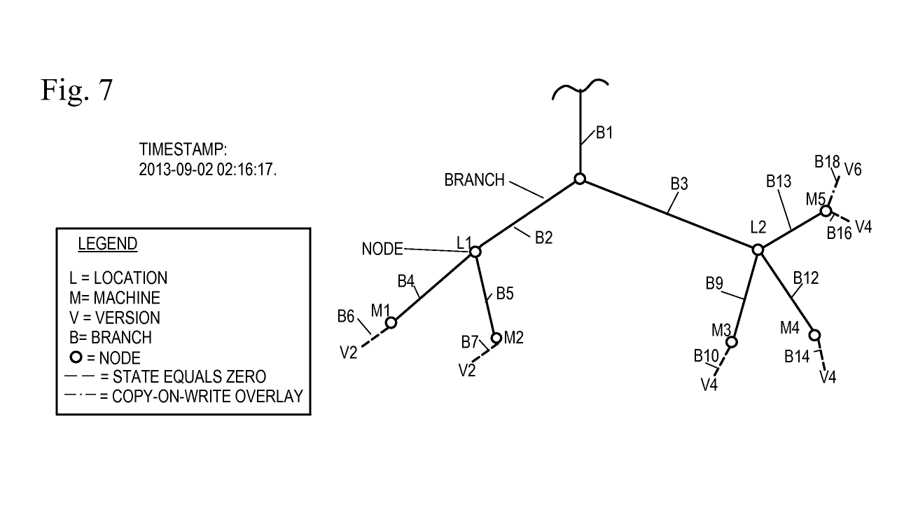

FIGS. 5-7 show examples of different states of a portion of the data structure at different times, within an embodiment of the present invention. FIG. 5 shows an example of a first state of a portion of the data structure at a first timestamp within the metadata layer of an embodiment of the present invention. FIG. 6 shows an example of a second state of a portion of the data structure at a second, later timestamp within the metadata layer. FIG. 7 shows an example of a third state of a portion of the data structure at a third, even later timestamp within the metadata layer.

Referring to FIG. 5, the state of a portion of the data structure within the metadata layer is shown in a graph structure with nodes separating the branches of the graph structure. Branches from the state at time-equals-zero or an initial set state (e.g. after an accepted or committed update) are separate databases or “memories” of the system of the data structure. Therefore, any branches extending from the same node as the branch of time-equals-zero state, act as snapshots of a system state exemplified as copy-on-write overlays. Committing a branch to other parts of the system or other branches is equivalent to merging data or databases. Branches of the graph structure may be committed to the entire system of the data structure (all of the branches) or only a portion of the data structure (one or more sub-branches). Processes may also maintain a branch of current state, instead of committing a change or update. The graph structure is continually updated within the metadata layer as the versions are changed or committed.

Multiple branches and sub-branches are supportable, although in the examples of FIGS. 5-7, only a few are shown. Branch identifiers and timestamps are preferably used with all transactions within the data structure to track consistency and resolve commit operations, allowing for database multi-temporality.

In this first example, the timestamp of the data structure is for the date of Sep. 2, 2013 at 2:10:15. At this timestamp, the state of the system shows that branch B1 splits at a node into branch B2 and branch B3. Branch B2 leads to another node, which is at location L1. At location L1, there are two machines present, M1 and M2, branching from location L1 through branches B4 and B5. Each machine M1, M2, has its own node and associated sub-branches.

The dashed line within the Figure represents a time-equals-zero state. The dash-dot-dash line represents a different state through a copy-on-write overlay of at least one data item. The copy-on-write overlay of at least one data item is stored locally on each of the machines as indicated. Alternatively, the copy-on-write overlay may be stored within the cloud computing environment 50, on a dedicated database 104a-104n or distributed across multiple databases 104a-104n.

Machine M1 has a single branch, B6, and is using version V1 of a data item, which for this example is equal to the time-equals-zero state. Machine M2 has two sub-branches, branch B7 using version V1, and another sub-branch B8 with at least one data item in another state, referred to as version V2. The user of machine M2 can alter the data item of the copy-on-write overlay.

Branch B3 leads to another node which is at location L2. At location L2, there are three machines present, M3, M4 and M5, branching from location L2 through branches B9, B12, B13. Each machine M3, M4, M5, has its own node and associated sub-branches. As before, the dash-dot-dash line represents a different state of at least one data item, through a copy-on-write overlay. The copy-on-write overlay of at least one data item may be stored locally on each of the machines as indicated.

Machine M3 has two sub-branches, branch B10 using version V1 and another branch B11 with at least one data item in another state, referred to as version V3. The user of machine M3 can alter the at least one data item of the copy-on-write overlay only locally on machine M3. Similarly, machine M4 also has two sub-branches, B 14 using version V1 and branch B15 with at least one data item in another state, referred to as version V4, and machine M5 has three branches—B16 using version V1, B17 with another version V5, and branch B18 with yet another version V6.

FIG. 6 shows the same two locations L1, L2 and five machines M1-M5 as in FIG. 5, but at a timestamp of Sep. 2, 2013 at 2:12:15, two minutes later than the state of FIG. 5. In between FIGS. 5 and 6, in location L1, a user initiated an update of the at least one data item with the changes initiated in version V2 of machine M2's copy-on-write overlay of the at least one data item. The extent of the at least one data item update, e.g. which, how many, and where the machines are that get updated may be determined by the user initiating the update, the level of authority of the user, and partly by the consistency rules of the data structure and system.

For the update of the machines to version V2, machine M2 at location L1 may have specified, for example, that all of the machines in locations L1 and L2 needed to be updated. The consistency rules may have been strict, in that all of the machines in both locations update the at least one data item completely, or that no machines in either location update the item. For the sake of this example, all of the machines have updated the at least one data item as a whole and are fully complete.

FIG. 7 shows the same two locations L1, L2 and five machines M1-M5 as in FIGS. 5-6, but at a third timestamp of Sep. 2, 2013 at 2:16:17, four minutes later than FIG. 6. At this timestamp, the locations L1, L2 have different versions used as the time-equals-zero state, with location L1 using version V2 and location L2 using version V4. In comparing FIG. 6 to FIG. 7, branch B17 was deleted or removed, and thus was not committed, and version V4 was committed by machine M4 to only the sub-branches of location L2. Therefore, the machines M1-M2 at location L1 are using one version V2 as the time-equals-zero version, and machines M3-M5 at location L2 are using version V4 as the time-equals-zero version of the dataset.

The different states of the data structure, for example as shown in FIGS. 5-7 are each maintained within the metadata layer 102. While the most current state may be, in this example FIG. 7, each state, as shown in FIGS. 5-6 may be searched for through a query and generated at any time as discussed below in steps 302-306.

It should be noted that while the timestamp is shown in the format of year-month-day hour: minutes: seconds in FIGS. 5-7, other formats may also be used. It should also be noted that the designation of numbering of the branches, machines, sub-branches, and versions is for example purposes only and any other formats may be used.

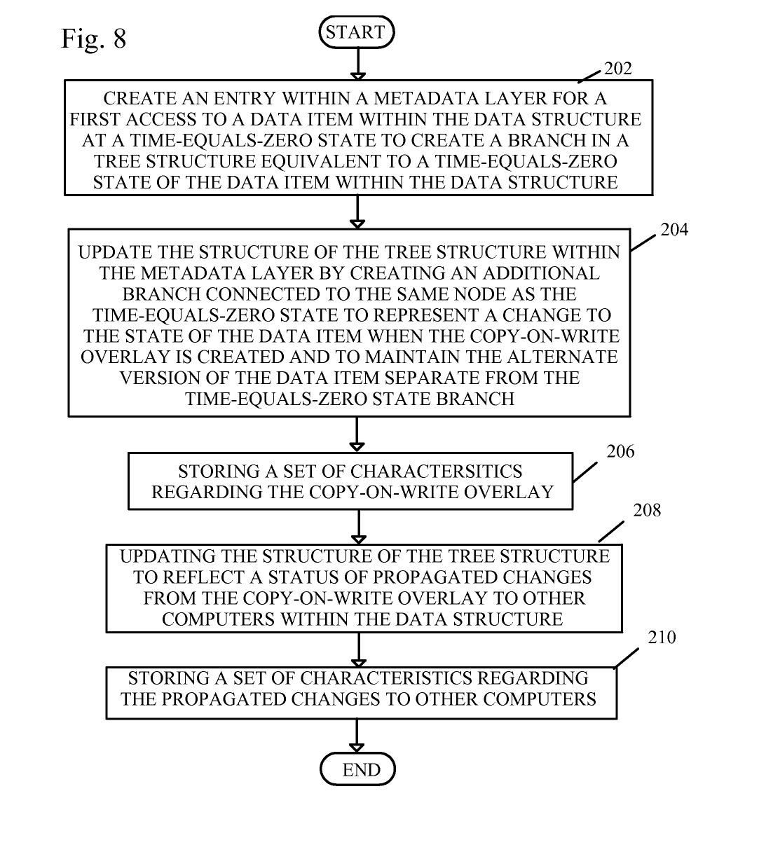

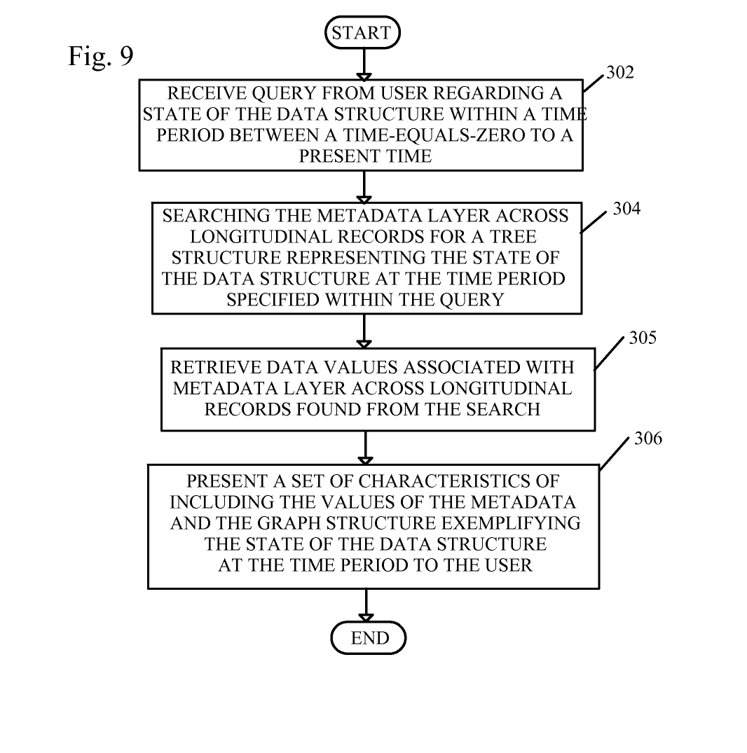

FIGS. 8-9 show flow diagrams of a method of creating and updating data regarding characteristics of a data item of a data structure within a metadata layer of a multi-temporal widely distributed hardware and software transaction state and data state memory system.

In a first step, the system, creates an entry within the metadata layer for a first access to a data item within the data structure at a time-equals-zero state to create a branch in a graph structure equivalent to the time-equals-zero state of the data item within the data structure (step 202).

The system updates the structure of the graph structure within the metadata layer by creating an additional branch connected the same node as the time-equals-zero state to represent a change to the state of the data item when a copy-on-write overlay is created and to maintain the alternate version of the data item separate from the time-equals-zero branch (step 204). When the copy-on-write overlay is created, an additional sub-branch is formed from a node as shown in FIGS. 5-7.

The system storing a set of characteristics regarding the copy-on-write overlay (step 206). The characteristics may include, for example timestamp, which user created the alternate version, what user initiated the alternate version, machines successfully propagated to, machines unsuccessfully propagated to, timestamp in which propagation was attempted, timestamp in which propagation was successful, timestamp in which propagation was unsuccessful, specific changes made within the alternate version, security level and what branches the alternate version was committed to.

The system updating the structure of the graph structure to reflect a status of propagated changes from the copy-on-write overlay to other computers within the data structure (step 206).

The system storing a set of characteristics regarding the propagated changes to other computers (step 208). The characteristics may include, for example timestamp, which user created the alternate version, what user initiated the alternate version, machines successfully propagated to, machines unsuccessfully propagated to, timestamp in which propagation was attempted, timestamp in which propagation was successful, timestamp in which propagation was unsuccessful, specific changes made within the alternate version, security level and what branches the alternate version was committed to.

FIG. 9 shows a flow diagram of a method of searching for information regarding updates made to the data structure of a multi-temporal widely distributed hardware and software transaction state and data state memory system. It should be noted that reports generated are not the same as a simple log of whether an updated version of the data item propagated or committed successfully.

In a first step, a query is received from a user or client regarding a state of the data structure within a time period between a time-equals-zero to a present time (step 302).

The system of the data structure searches the metadata layer across longitudinal records for a graph structure representing a state of the data structure at the time period specified within the query and associated metadata (step 304).

The system retrieves the data vales associated with the metadata from the data structure (step 305).

The system presents, to a user, a set of the characteristics of the data values associated with the data structure and the graph structure exemplifying the state of the data structure at the time period to the user (step 306). The set of characteristics and the graph structure generates a report regarding the propagated changes to at least one data item within the data structure to show at least a snapshot of the data structure and associated branches at a given time. The report may include metadata information or values regarding a timestamp, which user created the alternate version, what user initiated the alternate version, machines successfully propagated to, machines unsuccessfully propagated to, timestamp in which propagation was attempted, timestamp in which propagation was successful, timestamp in which propagation was unsuccessful, specific changes made within the alternate version, security levels, and what branches the alternate version was committed to. The report allows the propagation of changes to be tracked through various characteristics and paths.

The methods of the present invention may be implemented within mixed integer programming and hardware-accelerated real time decision tree analytics. For example recursive operations may create a change to a data item and then commit, delete, or keep large branching state structures.

The methods of the present invention may be embodied in hardware memory and/or storage controller that virtualizes a global address space.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Aspects of the present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method, in a multi-temporal widely distributed hardware and software transaction state and data state memory system comprising a plurality of computers, of initiating a change to a data structure comprising a plurality of databases and a metadata layer linking the plurality of databases and the plurality of computers, the steps comprising:
a computer creating an entry within the metadata layer for a first access to a data item within the data structure at a time-equals-zero state to create a time-equals-zero version branch of the data item in a graph structure of the data structure at a time-equals-zero time;
the computer updating the graph structure within the metadata layer when a copy-on-write overlay is generated by creating an additional branch connected to a same node as the time-equals-zero branch, to represent a change to a state of the of the data item and maintaining a co-existing alternate version of the data item, separate from the time-equals-zero version;
the computer storing a set of characteristics regarding the copy-on-write overlay within the metadata layer;
the computer updating the graph structure to reflect a status of propagated changes from the copy-on-write overlay to the plurality of computers; and
the computer storing a set of characteristics regarding the propagated changes to the plurality of computers.

2. The method of claim 1, further comprising:
the computer receiving a query from a user regarding a state of the data structure within a time period between the time-equals-zero time and a present time;
the computer searching the metadata layer for a graph structure representing the state of the data structure at the time period specified within the query and associated metadata;
the computer retrieving data values associated with the metadata;
the computer presenting, to a user, a set of characteristics comprising: the data values associated with the data structure and graph structure and the graph structure of the state of the data structure at the time period specified in the query to show at least a snapshot of the state of the data structure.

3. The method of claim 2, wherein the characteristics are selected from a group consisting of: a timestamp, which user initiated propagation of the changes in the alternate version to the at least one data item, the plurality of computers successfully propagated to, timestamp in which the propagation to the plurality of computers was successful, timestamp in which propagation to the plurality of computers was unsuccessful, specific changes made within the alternate version of the at least one data item, and what branches or sub-branches the alternate version was committed to.

4. The method of claim 1, wherein the set of characteristics the copy-on-write overlay within the metadata layer comprises characteristics selected from a group consisting of: a timestamp, specific changes made within the copy-on-write overlay of the at least one data item, security level of the data item, and the user whom initiated the copy-on-write overlay.

5. The method of claim 1, wherein the set of characteristics regarding the propagated changes to the plurality of computers comprises characteristics selected from the group consisting of: which user initiated propagation of the changes of the at least one data item to the plurality of computers, the plurality of computers successfully propagated to, timestamp in which the propagation to the plurality of computers was successful, timestamp in which propagation to the plurality of computers was unsuccessful, specific changes made within the alternate version of the at least one data item, and what branches the alternate version was committed to.
